(19) United States
(12) Patent Application Publication
(10) Pub. No.: US 2017/0101123 A1
(43) Pub. Date: Apr. 13, 2017

(54) STEERING WHEEL FOR A MOTOR VEHICLE

(71) Applicant: AUDI AG, Ingolstadt (DE)

(72) Inventors: ROBERT WANINGER, Ingolstadt (DE); Peter Pfitzmaier, Ingolstadt (DE); Peter Schleburg, Unterhaindlfing (DE)

(73) Assignee: AUDI AG, Ingolstadt (DE)

(21) Appl. No.: 15/287,861

(22) Filed: Oct. 7, 2016

(30) Foreign Application Priority Data
Oct. 7, 2015 (DE) 10 2015 013 009.9

(51) Int. Cl. B62D 1/06

(52) U.S. Cl. CPC B62D 1/06

(57) ABSTRACT

A steering wheel for a motor vehicle, includes a rim skeleton and at least one rim casing surrounding the rim skeleton, wherein the rim skeleton and the at least one rim casing rest upon each other with respective border surfaces, and wherein the border surfaces are displaceable relative to each other in at least one section.

### CROSS-REFERENCES TO RELATED APPLICATIONS

This application claims the priority of German Patent Application, Serial No. 10 2015 013 009.9, filed Oct. 7, 2015, pursuant to 35 U.S.C. 119(a)-(d), the content of which is incorporated herein by reference in its entirety as if fully set forth herein.

### BACKGROUND OF THE INVENTION

The present invention relates to a steering wheel for vehicle

The following discussion of related art is provided to assist the reader in understanding the advantages of the invention, and is not to be construed as an admission that this related art is prior art to this invention.

Steering wheels in vehicles are used by a driver to change a direction of the vehicle by turning the steering wheel. Because the general trend in vehicle construction is toward weight reduction, structures that are more lightweight are often also used in steering wheels. However, these structures are already excited to vibrate by low excitation energies which is why measures are required that dampen these interfering vibrations. On one hand it is sought to configure the own frequency of the steering wheel so that the own frequency is not excited by external excitation and on the other hand additional vibration dampers are incorporated in the steering wheel.

It would be desirable and advantageous to provide a steering wheel for a vehicle in which interfering vibrations can be dampened with simple means.

### SUMMARY OF THE INVENTION

According to one aspect of the invention steering wheel for a motor vehicle, includes a rim skeleton and at least one rim casing surrounding the rim skeleton, wherein the rim skeleton and the at least one rim casing rest upon each other with respective border surfaces, and wherein the border surfaces are displaceable relative to each other in at least one section.

Due to the fact that the border surfaces can be displaced relative to each other in at least one section friction is necessarily created between the border surfaces, which absorbs vibration energy. As a result of this defined friction the generated response frequency of the rim skeleton can fade significantly faster and with this reduce the vibration amplitudes overall. The relative displacement path between the border surfaces is also to be understood as a complete relaxing displacement which results from an elastic deformation between the border surfaces. The damping rate can be modified by the appropriate selection of friction partners, i.e., the two border surfaces. In addition as a result of the separation of the rim skeleton and the rim casing a multi-mass vibrator is generated, which enables influencing the response frequency of the entire steering wheel in a targeted manner. The rim skeleton is preferably made of a metal alloy, for example based on iron, aluminum or magnesium. The rim casing on the other hand may essentially be made of foamed polyurethane. The steering wheel as such usually has a central steering hub which is connected with a steering wheel rim via one or multiple steering wheel spokes. The rim skeleton extends at least within the steering wheel rim and preferably also into the steering wheel spokes where it provides the required mechanical stability to the steering wheel. The rim casing predominantly serves for providing a desired haptic for the driver of the vehicle.

According to another advantages feature of the invention, the border surfaces are outside the at least one section adhesively connected with each other. This prevents that the relative displacement of the rim casing relative to the rim skeleton is excessive which may adversely affect the function and the aesthetic appearance. An adhesive connection can be accomplished by introducing an adhesive between the rim skeleton and the rim casing outside the at least one section or directly when foaming the rim casing about the rim skeleton by using a material for the rim casing that has adhesive properties.

According to another advantages feature of the invention, the relative discplacabiltiy of the border surfaces is achieved by a corresponding material pairing and/or surface property of the border surfaces. In this regard for example material pairings are advantageous that can slide easily relative to each other in the absence of a bonding agent. As an alternative or in addition the surfaces of the corresponding border surfaces can be configured so that a desired friction with sufficient relative displacement is given.

According to another advantages feature of the invention, a glide element is introduced between the border surfaces in the at least one section. A glide element enables a targeted relative displacement of the border surfaces to each other by modifying the adhesion of the border surfaces in the at least one section.

According to another advantages feature of the invention, the glide element is a silicone. A silicone separates the two border surfaces in the at least one section reliably and absorbs a portion of the friction energy during the relative displacement of the border surfaces.

According to another advantages feature of the invention, the glide element is a braid. The braid in form of a metal or plastic braid is placed around the rim skeleton in the at least one section and increases the friction losses between the border surfaces correspondingly.

According to another advantages feature of the invention, the glide element is a granulate. The granulate contains macroscopic solids which increase the friction losses between the border surfaces in the at least one section and at the same time reduces the quasi elastic deformations. The granulate can contain metal shavings, plastic or fibers. Preferably the diameter of the solids is smaller by about one ten potent ha the gap between the border surfaces that they fill. When fibers are used these fibers can be longer in longitudinal direction than the width of the gap between the border surfaces.

According to another advantages feature of the invention, the rim casing is multilayered, and is in particular composed of different paired border surfaces. A multilayered construction enables a more complex rim casing for example with special top materials such as a leather cover. The layer of leather would then be pulled over the foamed polyurethane. In addition further components such as electrical wires for a steering wheel heating or capacitive or resistive sensors as metal layers and/or metal coatings can be incorporated in the rim casing. The embodiments of the border surfaces can be selected according to the desired properties.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a steering wheel for a vehicle; and

FIG. 2 shows a cross section through a part of a steering wheel.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

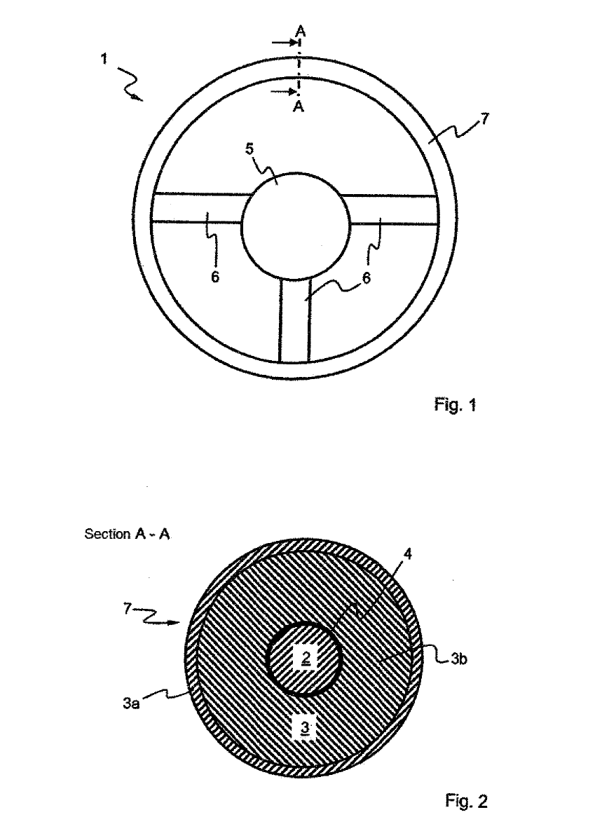

FIG. 1 shows a steering wheel 1 which has a steering wheel hub 5, which is connected with a steering wheel rim 7 by means of multiple steering wheel spokes 6. The steering wheel rim 7 is the part of the steering wheel 1 which the driver usually grips for inputting the steering request. The steering wheel hub 5 is connected with a not shown steering column via which the vibrations from the road or the aggregates of the vehicle are transmitted into the steering wheel 1.

FIG. 2 shows a view through the steering wheel rim 7 of FIG. 1 taken along line A-A. Accordingly the steering wheel rim 7 has in its center a rim skeleton 2 made of magnesium, which ensures the stability of the steering wheel rim 7. The rim skeleton 2 is encased by a rim casing 3 which in the present case has a multilayered construction with a base body 3b made of polyurethane and a leather cover 3a that covers the base body, and which the driver can grip. The border surfaces of the base body 3b of the rim casing 3 and the rim skeleton 2 lie on top of each other. In at least one section along the circumference of the steering wheel rim 7 a glide element 4 is introduced between these border surfaces, which permits a friction subjected relative movement of the rim casing 3 relative to the rim skeleton 2 in this at least one section. Otherwise the base body 3b rim casing 3 is adhesively connected with the rim skeleton.

What is claimed as new and desired to be protected by Letters Patent is set forth in the appended claims and includes equivalents of the elements recited therein:

What is claimed is:

1. A steering wheel for a motor vehicle, comprising:
a rim skeleton; and
at least one rim casing surrounding the rim skeleton, wherein the rim skeleton and the at least one rim casing rest upon each other with respective border surfaces, said border surfaces being displaceable relative to each other in at least one section.

2. The steering wheel of claim 1, wherein the border surfaces outside of the at least one section are adhesively connected with each other.

3. The steering wheel of claim 1, wherein a displacability of the border surfaces relative to each other is accomplished by a material pairing and/or surface property of the border surfaces.

4. The steering wheel of claim 1, further comprising a glide element provided between the border surfaces in the at least one section.

5. The steering wheel of claim 4, wherein the glide element is a silicone.

6. The steering wheel of claim 4, wherein the glide element is a braid.

7. The steering wheel of claim 4, wherein the glide element is a granulate.

8. The steering wheel of claim 1, wherein the rim casing is constructed multilayered.
